(19) United States
(12) Patent Application Publication
(10) Pub. No.: US 2008/0313686 A1
(43) Pub. Date: Dec. 18, 2008

(54) HANDHELD CAMCORDER ACCESSORY WITH PRE-PROGRAMMED WIRELESS INTERNET ACCESS FOR SIMPLIFIED WEBCASTING AND HANDHELD CAMCORDER WITH BUILT-IN PRE-PROGRAMMED WIRELESS INTERNET ACCESS FOR SIMPLIFIED WEBCASTING AND METHOD OF COMMERCIALLY SUPPLYING AND SUPPORTING SAME

(76) Inventor: Thomas R. Matvey, Aliquippa, PA (US)

Correspondence Address: BLYNN L. SHIDELER;THE BLK LAW GROUP, 3500 BROKKTREE ROAD, SUITE 200, WEXFORD, PA, 15090, US

(21) Appl. No.: 12/139,061

(22) Filed: Jun. 13, 2008

Related U.S. Application Data
(60) Provisional application No. 60/943,683, filed on Jun. 13, 2007.

(51) Int. Cl. H04N 7/173

(52) U.S. Cl. 725/109

(57) ABSTRACT

A handheld camcorder or camcorder accessory and designated webpage combination is provided, wherein the camcorder records onto a designated medium and the camcorder or camcorder accessory has an integrated wireless transmitter and receiver unit, an integrated web browser, and wherein the camcorder or camcorder accessory is pre-programmed, by default, to allow for webcasting to the designated web page; and wherein the designated webpage is programmed to receive and display the video transmission from the camcorder. The handheld camcorder or camcorder accessory having wireless internet access allows for a pre-programmed, one button webcasting, whereby a user that is familiar only with the basic operation of the camcorder can effectively webcast.

This application claims the benefit of provisional patent application 60/943,683 filed Jun. 13, 2007 entitled “Handheld Camcorder with Pre-Programmed Wireless Internet Access for Simplified Webcasting”

### BACKGROUND OF THE INVENTION

1. Field of the Invention

The present invention relates to a handheld camcorder or camcorder accessory having wireless internet access allowing for a pre-programmed, one button webcasting.

2. Background Information

Over the last 30 years handheld video recording devices, referenced herein as handheld camcorders, have become a staple consumer product. These devices have become very widely utilized and allow inexperienced users to record events, e.g. graduations, weddings, family gatherings, vacations and the like, onto the selected medium. The recording medium may be a VHS tape, a computer disc, or a removable or downloadable computer memory device, and others.

Within the meaning of this application a “camcorder” is a device having an integral recording medium for recording and storing video images. Consequently “webcams” will generally not fall within this definition as they would generally require an associated computer, e.g. laptop, for the recording and storage of the video image. With the merging of technology, other devices can fall within this expansive definition of “camcorder”, such as cell phones with built in video camera technology. Cell phone cameras, however, typically do not provide the picture quality and control desired by users for general video recording use, also called general camcorder use. Laptop computers with built in webcams can also fall within the broad definition of camcorder. The phrase “handheld camcorder” within the meaning of this application will be camcorders that are designed for one handed holding operation as a portable, “point and shoot” type video recording device. Therefore current laptop computers with built in webcams are not handheld camcorders.

More recent than the consumer acceptance of handheld camcorder is the explosive growth in the internet. The speeds and accessibility of the internet has allowed video clips and streaming video to become a staple of the internet. Extremely popular websites, such as www.myspace.com and www.youtube.com, have arisen that encourage and allow participants to upload video clips for wide spread viewing. Within the meaning of this application the uploading of a video image to an internet website and/or the broadcasting or streaming of a video image over an internet website will collectively be referenced as webcasting.

The conventional method of webcasting today is to transfer a recorded video clip to a computer having internet access and then having the computer access the desired website and upload the selected clip. The wide expansion of wireless networks, e.g. WI-FI and Bluetooth technologies, has allowed the associated computer to be free from a physical connection, but the webcasting process is still, typically a multistage process that requires the users to have some familiarity and experience with the webcasting process and prior knowledge of the associated receiving website. Further the multi-step process makes webcasting from a handheld camcorder in real time difficult for most of the public.

### SUMMARY OF THE INVENTION

The objects of the present invention is to provide a handheld camcorder having wireless internet access allowing for a pre-programmed, one button webcasting, whereby a user that is familiar only with the basic operation of the camcorder can effectively webcast.

One embodiment of the present invention provides a handheld camcorder accessory to be coupled to and integrated with a handheld camcorder and designated webpage combination, wherein the camcorder records onto a designated medium and has an integrated wireless transmitter and receiver unit, an integrated web browser, and wherein the camcorder is pre-programmed, by default, to allow for webcasting to the designated web page; and wherein the designated webpage is programmed to receive and display the video transmission from the camcorder.

One embodiment of the present invention provides a handheld camcorder and designated webpage combination, wherein the camcorder records onto a designated medium and has an integrated wireless transmitter and receiver unit, an integrated web browser, and wherein the camcorder is pre-programmed, by default, to allow for webcasting to the designated web page; and wherein the designated webpage is programmed to receive and display the video transmission from the camcorder. One embodiment of the present invention provides a process for wireless webcasting comprising the steps of (i) providing a webcasting customer with a handheld camcorder or camcorder accessory having an integrated wireless transmitter and receiver unit, an integrated web browser, wherein the camcorder or camcorder accessory is pre-programmed, by default, to allow for webcasting to a designated web page, and wherein the designated webpage is programmed to receive and display the video transmission from the camcorder; (ii) identifying at least one accessible wireless network having internet access; (iii) connecting the wireless transmitter and receiver unit to the wireless network; and (iv) operating the camcorder to simultaneously recording video to the medium of the camcorder and webcasting to the designated web page. The digital video process incorporated into the camcorder and camcorder accessory may include a data compression system to provide for exceptional video quality and full computer screen viewing.

These and other advantages of the present invention will be clarified in the brief description of the preferred embodiment taken together with the drawings in which like reference numerals represent like elements throughout.

### BRIEF DESCRIPTION OF THE DRAWINGS

FIG. 1 is a schematic diagram of a handheld camcorder having integrated wireless internet access allowing for a pre-programmed, one button webcasting to a designate website in accordance with the present invention;

FIG. 2 is a schematic view of the handheld camcorder of FIG. 1 having integrated wireless internet access allowing for a pre-programmed, one button webcasting according to one aspect of the present invention; and

FIG. 3 is a schematic diagram illustrating the point of sale activation of the designated website for the handheld camcorder of FIG. 1;

FIG. 4 is a schematic diagram of a handheld camcorder having integrated camcorder accessory providing wireless internet access allowing for a pre-programmed, one button webcasting to a designate website in accordance with the present invention; and

FIG. 5 is a schematic diagram of a handheld camcorder having integrated camcorder accessory providing wireless internet access allowing for a pre-programmed, one button webcasting to a designated website in accordance with the present invention.

### DESCRIPTION OF THE PREFERRED EMBODIMENTS

FIG. 2 a schematic view of is a schematic diagram of a handheld camcorder 10 having integrated wireless internet access allowing for a pre-programmed, one button webcasting to a designated website in accordance with the present invention. The camcorder will have conventional controls 12 for operation of the camcorder 10 for recording onto a conventional video storage medium such as VHS tape, Downloadable or removable memory of the camcorder 10 (e.g. a USB port flash memory stick, writable CD, etc), or other conventional known medium. The camcorder 10 will have all the various inputs and outputs for coupling to external devices as known in the art.

The operation and control of the camcorder 10 through controls 12 are conventional and known in the art and are not described in further detail herein. The position of the controls 12 and the shape of the housing for the camcorder 10 are not material and can take many ergonomic forms that are acceptable for one handed operation.

As shown in FIG. 2 the camcorder 10 according to the present invention includes an integrated wireless transmitter and receiver unit 14, e.g. a Wi-Fi card, Bluetooth™ technology, broadband card access, or a satellite linkup, and an integrated web browser 16. As will be described in greater detail below the camcorder 10 is pre-programmed, by default, to allow for webcasting to a designated web page 20 having a web address 22 preferably designated by the user. The webpage 20 is programmed or configured to receive and display the video transmission from the camcorder 10. The internet file transfer protocols allowing for video transmission over the internet are well known and not described herein.

When the wireless unit 14 identifies at least one accessible network 30 having internet 40 access, the wireless unit 14 will connect thereto and the user will be notified that webcasting is possible by an indicator light 24 on the camcorder 10. The present invention is intending to simplify the operation of the camcorder 10 for webcasting so the camcorder 10 may have an automatic default setting of accessing the network 30 with the strongest signal. The accessible networks 30 will generally be “unsecured” networks, but may include secured networks that the camcorder 10 has been authorized for.

The wireless unit 14 may further employ network switching methodologies should the primary network 30 have a fading or lost signal. The system may further employ audible alerts should one network 30 be lost with no replacement network within range (similar to a call dropped alert for cell phones). Wireless transmitter and receiver technology for units 14 is well known in the art for both laptop computers and for cell phones.

The web browser 16 is also well known software that allows for internet communication and navigation. The web browser 16 of the present invention has a default dedicated interaction, i.e. preprogrammed, with the web page 20 associated with the handheld camcorder 10.

The camcorder 10 includes a webcasting button or toggle 26 that, when a network 30 is in range as identified to the user by indicator light 24, can be depressed or activated to allow for webcasting of the images being recorded to webpage 20. The toggle 26 can act as a simultaneous record and webcast button such that, when depressed the camcorder 10 will record in a conventional fashion and simultaneously webcast to the designated webpage 20 (i.e. live broadcasting).

Alternatively the toggle 26 can be used to merely activate the webcasting capabilities, wherein the conventional play button of controls 12 is then be used to record and to simultaneously webcast from the camcorder 10 when the toggle 26 is activated (and wherein the play button will only record when the toggle 26 is not activated or the camcorder 30 is not associated with an accessible network 30). This is still considered “one button” operation. In this configuration, with the with toggle 26 “on”, the webcasting is through a single activation button (i.e. the play button). This configuration allows for webcasting of stored images through the invention. Camcorders 10 conventionally allow the user to review a recorded image on the camcorder 10. With the toggle 26 “on” the playback of a recorded image will also webcast this recording with the playback.

The choice of implementation is left to the manufacturer based upon perceived ease of use and understanding of operation. For example, the toggle 26 may be used to “turn the webcasting capabilities on” and only then will the unit 14 seek and connect to wireless networks 30 in range, with the play button of controls 12 used then as a one handed one button operation to simultaneously record and webcast or to playback and webcast. The indicator 24 can still be used to indicate when the network 30 is connected, with an audible or other alert given when webcasting is designated but not possible due to network unavailability. The indicator may include a graphical strength of signal bar as can be helpful to users.

When webcasting with camcorder 10, the real time video image 50 will be provided to the webpage 20 and viewable as a real time image 50 by those accessing the webpage 20. As noted above the image 50 may be a playback of a previously recorded image, which may, for example, be utilized where live broadcasting was unavailable because the camcorder was out of range. The webpage 20 will have a common web address preferably designated by the user or customer 70 as described below and unique to a particular camcorder 10.

The webpage 20 may further provide for a number of file and webpage management, file editing, security and other features to users and customers as will known in the art. For example, the customer 70 may designate to include password protection features to restrict access to the site. A customer password may be used that is different than ordinary user password so that the customer 70 is given greater management control over the page 20. The customer may be given tools to edit the look of the webpage 20. The users may be able to size the image 50 as desired. The webpage 20 will provide the real time image 50 of a live broadcast or a previously recorded playback as designated above, but may further record and store the image 50 and allow for later playback by users accessing the website 20.

The term “user” can include the customer 70 and others, as should be apparent from the present description. The password protection(s) may be for selected recorded images 50, in other words the customer 70 may select certain images to be password protected. The webpage 20 may allow for the customer 70 to add titles for the recorded clips 50, rather than merely default titles such as time and date. The webpage 20 may allow for the customer 70 to edit, merge or otherwise modify the recorded clips 50. A library of past video clips 50 can be made available to users of the particular page 50. Standard playback features for stored clips 50 can be provided such as pause, rewind, forward and the like.

The ability to upload other videos (that may or may not come from the camcorder 10) to the library can be provided. This can allow, for example, uploading of recorded images taken out of range of a network 30 as noted above. The ability of users to download video clips 50 from the library can also be provided.

The number of features that may be made available to the customer 70 (i.e. the purchaser of the camcorder 10) and the user's of the website 20 is not limited. For example, the website 20 may notify a list of contacts via e-mail or text message regarding webcasts through a customers personal setting (e.g. “John Doe is currently webcasting an event viewable at www.acmecamcorder.JohnDoe1.com with entry of the password “grandkids””). The website may offer CDs or downloads of recorded images and transfer to designated contacts.

The camcorder 10 according to the present invention includes an integrated wireless transmitter and receiver unit 14 and an integrated web browser 16 that have a default operation as noted above. The default operation is the essence of the present invention and is intended to bring easy webcasting to a wide variety of customers 70. With the presence of a display 32 and input device 34, e.g. a keyboard, on the camcorder 10 the “default” operation described above can be “overridden” and a new web page designated. For example, a company may elect to have the webcasting sent to a company webpage, and the display 32 and input devices 34 will allow for interaction with the settings of the web browser 16 to change such settings or pre-programming. Appropriate software and customer interface is provided. If the input device 34 on the camcorder 10 is not convenient then reprogramming of the camcorder 10 may be through coupling to a computer. The present invention intends to allow for webcasting to those that do not feel sufficiently knowledgeable to do so and still provide a highly versatile camcorder 10 for those that do feel well versed in this technology (or that are not intimidated by the user manual). The present invention further intends to include a digital video process incorporated into the camcorder and camcorder accessory that will include a data compression system to provide for exceptional video quality and full computer screen viewing.

Further, the camcorder 10 need not operate over a wireless network 30 through unit 14. The camcorder 10 may connect via a wire connection to couple the web browser 1 6 to the internet 40 in a hardwired network setting. With the hardwired internet connection (not shown) the indicator 24 will identify the presence of the internet access and the camcorder 10 still used to webcast in essentially the same fashion as in the wireless operation. The wired network operation allows for coverage where a wired network is available and accessible wireless network 30 is not. However this option will likely limit the operation of the now tethered camcorder 10 and may be more confusing to techno phobic consumers. This operation is described merely to illustrate that the present invention is not intending to be limiting.

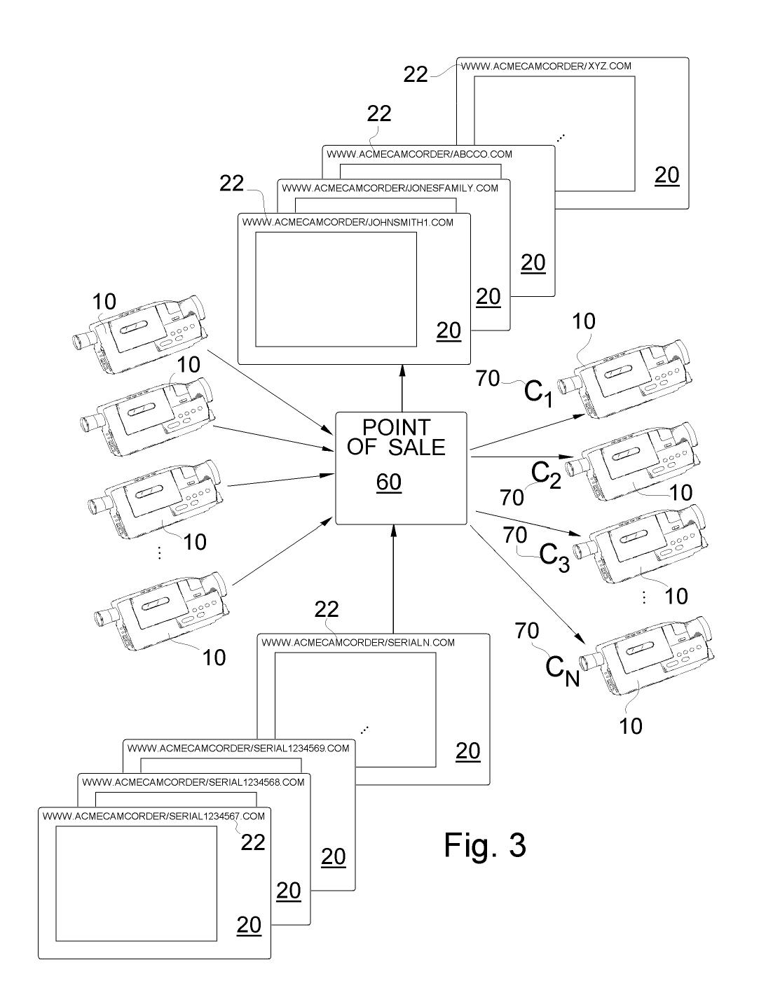

The default operation of the camcorder 10 of the present invention is better explained in a review of the point of sale or retailer 60 for the device. The manufacturer of the camcorders 10 will have a designated web page 20, or a potential designated web page 20, associated with each camcorder 10. This is schematically shown in FIG. 3 in which each camcorder 10 has a webpage 20, or a potential webpage 20 associated with that particular camcorder 10. At this point the web address 22 for each page 20 may include a unique camcorder designation, such as the serial number of the particular camcorder 10, and therefore easily be unique.

At the time the camcorder 10 is sold to a particular customer 70, the retailer 60 may ask what webpage “name” the customer 70 would like the designated webpage 20 to be under. The retailer 60 merely can check the availability of the name to confirm it is unique (e.g. “It appears we already have ‘JohnDoe’ is ‘JohnDoe1’ acceptable?”) and then “rename” the webpage 20 associated with the camcorder 10. In other words the address www.acmecamcorder.serial1234567.com becomes address www.acmecamcorder.JohnDoer1.com; and www.acmecamcorder.serial1234568 becomes www.acmecamcorder.thejonesfamily.com as designated by the respective customers 70. The renaming of the respective webpage 20 will also serve to activate such page 20 so the pages 20 are not actually needed, and need not exist, until the retailer 60 “renames” or requests them. This operation requires an internet connection between the retailer 60 and the operator of the website containing the pages 20, but many retailers 60 already possess such capability.

Alternatively the retailer 60 may give the customers 70 a toll free number and/or a website with code or the like for the customer 70 to access. For a web based application, after the customer 70 enters the unique password and serial number, it would be expected that a simple interview type interaction can be used to obtain user preferences and automatically set up the website with the user identifiable designation and other user settable parameters (e.g. password protected, certain features enabled, etc).

In a further alternative, coupling the camcorder 10 to the user's computer can automatically download software to user's computer that allows the user to program the webcasting capabilities of the camcorder 10, such as through an interview interaction.

Even a pre-paid postcard could be utilized that is mailed to the operator, the website named and activated and confirmation sent back to the customer 70, but this would slow the use of the device down some.

Obviously, the retailer 60 activated method described above minimizes customer 70 action and can be more widely embraced by techno-phobic users. In this manner a customer 70 with no particular knowledge of webcasting can walk into a retail outlet 60, purchase a camcorder 10 and identify a desired webpage name 22 to the retailer at time of check out and immediately commence real time webcasting to the designated page. Third parties, assuming no password protection is enabled, can immediately access the webcast in real time. As a representative example, a family member (e.g. parent or grandparent) can purchase the camcorder 10 on the way to a family event and webcast the family event (e.g. graduation, wedding, state championship game, etc) and allow remote family members view the event in real time via the internet by only providing the address (and password if designated). The camcorder 10 will, of course, also have the conventional recording of the event on the appropriate medium.

The operators of the current system can utilize a wide variety of business models for the implementation of this invention. For example, only a limited number of features may be made available to the users of the webpages 20, such as only real time webcasting (e.g. video streaming), but no storage, replay or the like of the video clips 50 unless a “premium” membership is purchased by the customer 70 for a monthly fee. Alternatively all of the features may be accessible for a short period of time, e.g. a 90 day free trial period from point of purchase, and membership then needed to maintain such features beyond the trial period. The default service may require a membership to activate at the beginning, meaning that if the camcorder 10 is purchased without the service, then the default settings must be “overridden” to utilize the webcasting features of the camcorder 10 on another website other than webpage 20. The operator may charge the user only for use of the webpage 20, unless a membership agreement is entered into; e.g. a fixed fee when webcasting feature is used and the videos are retained for a limited period (e.g. 30 days) and are then discarded. The business models are limitless.

The term operator is used herein to describe the entity that is running the collection of webpages 20, and this entity may be different from the manufacturer of the camcorder 10 and further different from the retailer 60. If the operator is the same as the manufacturer, the webpages 20 may not be operated as a fee per service arrangement, but may simply be used by the manufacturer to promote and sell the camcorder 10, i.e. it may be free to the customers 70. The particulars of the web page 20 business models will, of course, be critical in implementing the present invention, but they are largely immaterial in understanding the operation of the present invention, other than to illustrate the flexibility of the present invention.

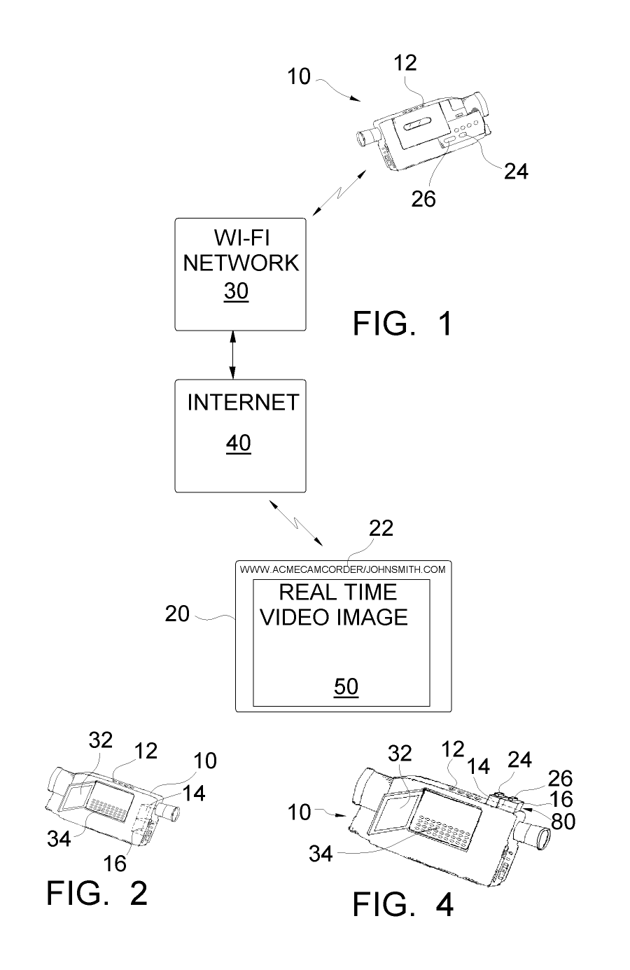

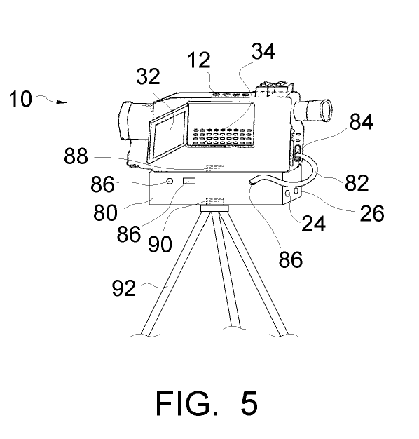

FIGS. 4 and 5 illustrate another embodiment of the present invention. In this embodiment the camcorder 10 according to the present invention also includes an “integrated” wireless transmitter and receiver unit 14 and an “integrated” web browser 16 in the form of an attached camcorder accessory 80. The unit 14 and web browser 16 software are provided in an attachable unit 80 that can be coupled to the camcorder 10 and carried therewith. The unit 80 will not interfere with the one handed operation of the camcorder 10. The unit 80 includes the indicator 24 and the toggle 26 described above. With the unit 80 attached to and carried with the camcorder 10, the system operates as described above in connection with FIGS. 1-3. With the unit 80 unattached to the camcorder 10, the camcorder 10 operates as a conventional camcorder. The unit 80 allows the present invention to be retrofitted to existing camcorders, provided the unit 80 can be designed to be coupled to the existing camcorder in a manner that allows it to travel with the camcorder and not interfere with one handed operation thereof. Within the meaning of the present invention a camcorder accessory 80 may be considered integral with the camcorder if it is coupled to the camcorder, carried with and effectively on the camcorder and does not interfere with one handed operation of the camcorder.

The unit 80 will allow the manufacturer to separate the present invention features from the camcorder 10 aspects of the product. Further, it should be apparent that in this embodiment the retailer 60 would only need to designate the webpage 20 with the sale of the unit 80 (which may be with or without the camcorder 10). This embodiment provides the unit 80 as an easy to use webcasting accessory to the camcorder 10. Despite the ease of use the “accessory” aspect of the unit 80 may make it less attractive to the target user of the present invention (e.g. those that tend to be techno-phobic) than the non-accessory embodiment described above. This embodiment is presented to illustrate the breadth of the present invention.

In the embodiment of FIG. 5 the unit 80 is intended to be coupled to the camcorder 10 through cable 82 and input 84 on the camcorder, such as USB port, S-cable connection, etc. The cable 82 is coupled to a corresponding input port 86 on the unit 80. A plurality of inputs 86 can be provided to allow for the unit 80 to couple to a variety of existing camcorder models and to utilize existing camcorder cables 82.

As shown in FIG. 5, one secure physical attachment mechanism between the unit 80 and the camcorder 10 is through a tri-pod attachment 88 on the unit 80 and associated camcorder 10. The attachment is typically a post type connection that is often threaded and this provides a secure attachment. With tri-pod attachment 88 on the unit 80 a corresponding attachment 90 is provided on the opposite side of the unit 80 to secure the unit 80 and associated camcorder 10 with a tripod 92.

The above description of the system is applicable with the integrated unit 80. For example with a web based application, after the customer 70 enters the unique password and serial number, a simple interview type interaction can be used to obtain user preferences and automatically set up the website with the user identifiable designation and other user settable parameters (e.g. password protected, certain features enabled, etc). Alternatively, coupling the camcorder accessory 80 to the user's computer via a USB port connection or the like can automatically download software to user's computer that allows the user to program the webcasting capabilities of the camcorder 10 with attached unit 80, such as through an interview interaction.

The unit 80 can include the controls as described above. Further the camcorder accessory 80 can include an on/off switch and indicator light, Wi-Fi connectivity, satellite connectivity, broadband card port, additional USB ports, input mechanism for programming (e.g. keyboard or keyboard coupling, touch screen, etc), and a battery or power source coupling.

A further feature of the present invention is to allow for broadcasting in high definition. The accessory 80 may further include conversion to allow for transmission in high definition for retrofitting of existing camcorders 10.

Although the present invention has been described with particularity herein, the scope of the present invention is not limited to the specific embodiment disclosed. It will be apparent to those of ordinary skill in the art that various modifications may be made to the present invention without departing from the spirit and scope thereof.

What is claimed is:

1. A process for wireless webcasting comprising the steps of
(i) providing a webcasting customer with a handheld camcorder having an integrated wireless transmitter and receiver unit, an integrated web browser, wherein the camcorder is pre-programmed, by default, to allow for webcasting to a designated web page, and wherein the designated webpage is programmed to receive and display the video transmission from the camcorder;
(ii) identifying at least one accessible wireless network having internet access;
(iii) connecting the wireless transmitter and receiver unit to the wireless network;
(iv) operating the camcorder to simultaneously recording video to the medium of the camcorder and webcasting to the designated web page.

2. The process for wireless webcasting according to claim 1 further including the step of activating the webpage at the retailer.

3. The process for wireless webcasting according to claim 2 further including the step of renaming the web address of the webpage by the customer at the retailer.

4. The process for wireless webcasting according to claim 2 further including the step of indicating when a wireless network is connected to the camcorder.

5. The process for wireless webcasting according to claim 2 further including the step of toggling the webcasting capabilities on and off on the camcorder.

6. The process for wireless webcasting according to claim 1 further including the step of renaming the web address of the webpage by the customer.

7. The process for wireless webcasting according to claim 1 further including the step of indicating when a wireless network is connected to the camcorder.

8. The process for wireless webcasting according to claim 1 further including the step of toggling the webcasting capabilities on and off on the camcorder.

9. A camcorder accessory for a handheld camcorder, the camcorder recording onto a designated medium, said accessory mechanically coupled to the camcorder and having an integrated wireless transmitter and receiver unit, an integrated web browser, wherein the camcorder accessory is pre-programmed, by default, to allow for webcasting to a designated web page.

10. The camcorder accessory according to claim 9 further including and indicator light on the camcorder accessory indicating when a wireless network is connected to the camcorder.

11. The camcorder accessory according to claim 10 further including a toggle switch for toggling the webcasting capabilities on and off on the camcorder accessory.

12. The camcorder accessory according to claim 9 further including a toggle switch for toggling the webcasting capabilities on and off on the camcorder accessory.

13. A handheld camcorder and designated webpage combination, wherein the camcorder records onto a designated medium and has an integrated wireless transmitter and receiver unit, an integrated web browser, and wherein the camcorder is pre-programmed, by default, to allow for webcasting to the designated web page; and wherein the designated webpage is programmed to receive and display the video transmission from the camcorder.

14. The handheld camcorder and designated webpage combination according to claim 13 further including and indicator light on the camcorder indicating when a wireless network is connected to the camcorder.

15. The handheld camcorder and designated webpage combination according to claim 14 further including a toggle switch for toggling the webcasting capabilities on and off on the camcorder.

16. The handheld camcorder and designated webpage combination according to claim 13 further including a toggle switch for toggling the webcasting capabilities on and off on the camcorder.

17. The handheld camcorder and designated webpage combination according to claim 13 wherein the designated webpage has a web address unique to the camcorder.

18. The handheld camcorder and designated webpage combination according to claim 13 wherein the webpage includes at least one webpage management feature

19. The handheld camcorder and designated webpage combination according to claim 13 wherein the camcorder is configured to be reprogrammed to allow for webcasting to another designated webpage other than the original designated web page.
